(19) United States
(12) Patent Application Publication
(10) Pub. No.: US 2026/0350491 A1
(43) Pub. Date: Nov. 5, 2026

(54) DRIVE UP AND GO PLATFORM

(71) Applicant: SAFEWAY INC., Pleasanton, CA (US)

(72) Inventors: Raj ANAND, Pleasanton, CA (US); Ramalakshmi VALA SUBRAMANIAN, Pleasanton, CA (US); Gurmail SINGH, Pleasanton, CA (US); Talal TALHOUK, Pleasanton, CA (US); Amit CHAUDHARY, Pleasanton, CA (US); Mahavir PAREKH, Pleasanton, CA (US); Atmika RAMANATH, Pleasanton, CA (US); Balaji NAMBI, Pleasanton, CA (US)

(21) Appl. No.: 19/668,330

(22) Filed: May 5, 2026

Related U.S. Application Data
(60) Provisional application No. 63/800,098, filed on May 5, 2025.

(51) Int. Cl. G06Q 10/02; G06F 3/14; G06Q 30/0601

(52) U.S. Cl. CPC G06Q 10/02; G06F 3/14; G06Q 30/0633; G06Q 30/0641

(57) ABSTRACT

Disclosed herein is technology for real-time alerting and prioritizing drive-up-and-go order information. The disclosed technology can perform operations including: receiving data about a orders including a vehicle check-in event, prioritizing how that information is displayed and updated based on that check-in event, and providing visual and audible alerts based on the time lapsed from the check in-event, employee actions taken in response to the check-in event, and other vehicle check-in events.

### TECHNICAL FIELD

Systems and methods are provided to coordinate and to drive visibility and alerts for drive-up-and-go handoffs, specifically related to notifying, driving, and prioritizing actions.

### BACKGROUND

Impediments to achieving on-time handoff goal in a curbside pickup customer experience is ensuring that all associates and store directors have constant visibility into arrivals. Additionally, knowing how many arrivals to expect and prioritizing arrivals helps associates better prepared for and execute handoff delivery.

### SUMMARY

Disclosed embodiment provide, a system for prioritizing and alerting users for drive-up-and-go (DUG) orders comprising a visual display configured to display and prioritize DUG orders based on a vehicle check-in event and other real-time information and a processor configured to push updates to the visual display based on time lapsed since vehicle check-in event including an alert that changes in how a vehicle priority is displayed and configured to push updates to an audible alert system to provide an audible alert based on elapsed time from the vehicle check-in event.

In some embodiments, the system further comprises a last mile event system, which detects and communicates the vehicle check-in event to the processor.

In some embodiments, a last mile event system detects the vehicle check-in event via geolocation services in the application or by a customer inputting updates in a user interface.

In some embodiments, the system further comprises a picking event system, wherein the picking events system includes a handheld device in communication with the processor.

In some embodiments, the picking event system provides updates to the status of the drive-up-and-go orders in the visual display.

In some embodiments, the picking event system provides updates that the order is in progress when a handheld tablet is activated for the DUG order.

In some embodiments, the processor is configured to coordinate the visual alert and the audible alert based on the time lapsed.

In some embodiments, the processor is configured to coordinate escalating visual and audible alerts based on predefined and longer time lapses.

In some embodiments, the processor is configured to cancel the audio alert and the escalating audio alerts, and to update the visual display in response to detection that the DUG order is in progress.

In some embodiments, the processor is further configured to identify that the vehicle check-in event has occurred for multiple DUG orders within a predefined period of time, and in response, to coordinate a single visual alert and a single audible alert corresponding to the time lapse for the multiple DUG orders.

In some embodiments, the processor is configured to coordinate an escalating visual alert and an escalating audible alert for the multiple DUG orders based on predefined and longer time lapses.

In some embodiments, the processor is configured to cancel the audio alert and updating the visual and audio alerts including canceling the audio alerts.

In some embodiments, the processor is further configured to identify that the vehicle check-in event has occurred for multiple DUG orders, and in response, to coordinate visual alerts to prioritize and signal which order should be handled first based the time lapse for the multiple DUG orders.

In some embodiments, in response to the time lapse for the multiple DUG orders exceeding a threshold, the processor coordinates a single alert for all of the multiple DUG orders, wherein the single alert communicates the urgency is greater than that of any previous alerts.

In some embodiments, in response to a total number of DUG order vehicle check-in events exceeding a threshold, the processor the processor coordinates a single visual alert for all of the DUG orders, wherein the single visual alert communicates the urgency is greater than that of any previous alerts.

In some embodiments, the audible alert system is an store public announcement system.

In some embodiments, the visual display comprises a plurality of in-store digital displays.

### BRIEF DESCRIPTION OF THE FIGURES

FIG. 1 displays a system architecture according to the disclosed embodiments;

FIG. 2 illustrates a flowchart of the various systems, data, and service elements of the disclosed embodiments;

FIG. 3 is an exemplary visual display of the system showing the prioritization of the layout order, space and size, to direct a user's attention to the items awaiting action;

FIG. 4 illustrates an exemplary gradation of notification via a progression of 3 alerts over time in an exemplary visual display according to the disclosed embodiments; and

FIG. 5 shows a vehicle waiting timeline with various timing thresholds that may control the one or more alerts in an exemplary visual display according to the disclosed embodiments.

### DETAILED DESCRIPTION

Systems and methods are provided to provide a platform to drive visibility and alerts for handoffs with an objective of driving actions and improving performance. With Drive Up and Go (DUG) dashboard on a digital display, a visual system is provided to see actionable handoff tasks and exceptions in a single place. Information hierarchy may be established based on frequency of usage and order of importance by key personas. This platform reduces cognitive overload by showing minimal information which will keep the display easy to read at quick glances between tasks. This platform allows associates to efficiently multi-task by displaying and prioritizing the right information without cognitive overload. In some embodiments, the platform prioritizes most actionable information by placing it at the top of the display and dedicating more screen real estate to the high priority information.

The platform includes a dashboard published on a digital display, such as a signage TV, backed by live streaming of order updates in store, which empowers associates to at a glance stay updated on order progress and upcoming arrivals enabling them to deliver faster, more organized service. With this real time dashboard, store associates get instant updates on incoming, in-progress or delayed orders. The streaming API integrates human and technological elements demonstrating how real-time data can improve communication within the team, ultimately enhancing the store's operational efficiency. Through collaborative UI design, non-disruptive visual alerts may also be provided that capture associates' attention, highlighting customers at risk of extended wait times. This visual system offers associates insight into order timing and performance metrics, enabling them to proactively manage support needs. It also empowers store managers with data-driven views to optimize staffing and ensure seamless customer support. In tandem with visual alerts, configurable audio notifications broadcast through the store's PA system inform associates who may be away from the screen of waiting customers, ensuring they stay engaged without causing disruption. This combination of audio and visual alerts enhances immediacy in response, reducing delays and positively impacting the customer experience. By using both visual and audio cues, this platform conveys real-time information so that associates are immediately aware of customer arrivals and order updates, as well as order prioritization, thereby reducing delays that typically frustrate customers.

Disclosed embodiments provide systems and methods that redefine curbside service by combining a real-time dashboard with visual and audio alerts to create an easier to digest user experience that results in exceptional customer experience. Displayed on any number of digital displays, including on in-store digital signage TVs, the dashboard provides associates with live updates on order statuses and customer arrivals, powered by a streaming API for seamless, instant information. The dashboard has incorporated visualizations and storytelling techniques to convey key insights and drive action, such as highlighting key performance indicators (KPIs) or trends. Visual and Audio alerts further enhance responsiveness by notifying associates when customers arrive or when actions have surpassed a designated time threshold, ensuring prompt service and a seamless handoff.

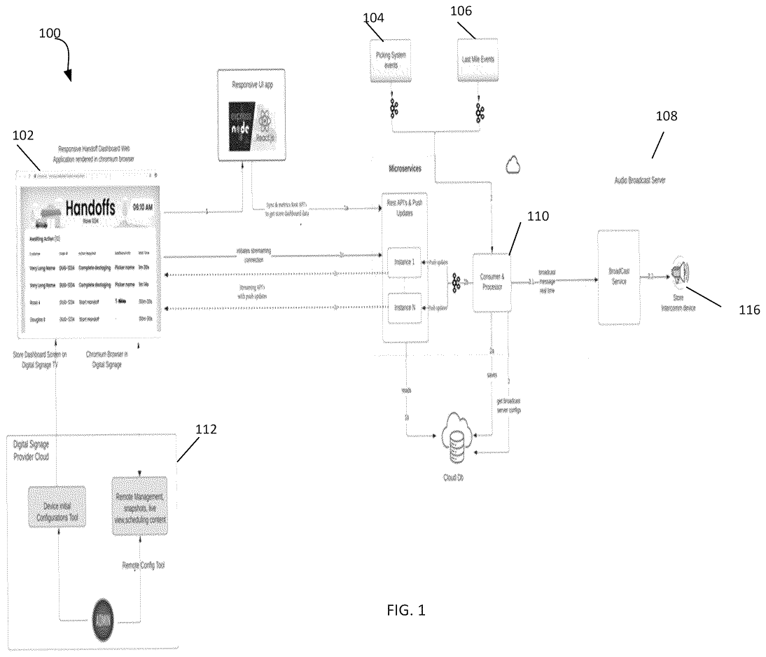

FIG. 1 displays an exemplary system architecture 100 of the platform including one or more displays 102, a picking system 104, and a last mile events system 106, and an audio broadcast server 108, each in communication with a central processor 110. Display 102 may be further in communication with a remote processor, computer, and/or cloud database 112 that provides for remote management and configuration of the display 102. Audio broadcast server 108 may include a broadcast service and network of one or more intercom devices 116. Central processor 110 is configured to detect predefined trigger events and coordinate communications related to the picking system 104 and last mile system 106 in both the display 102 and intercom devices 116.

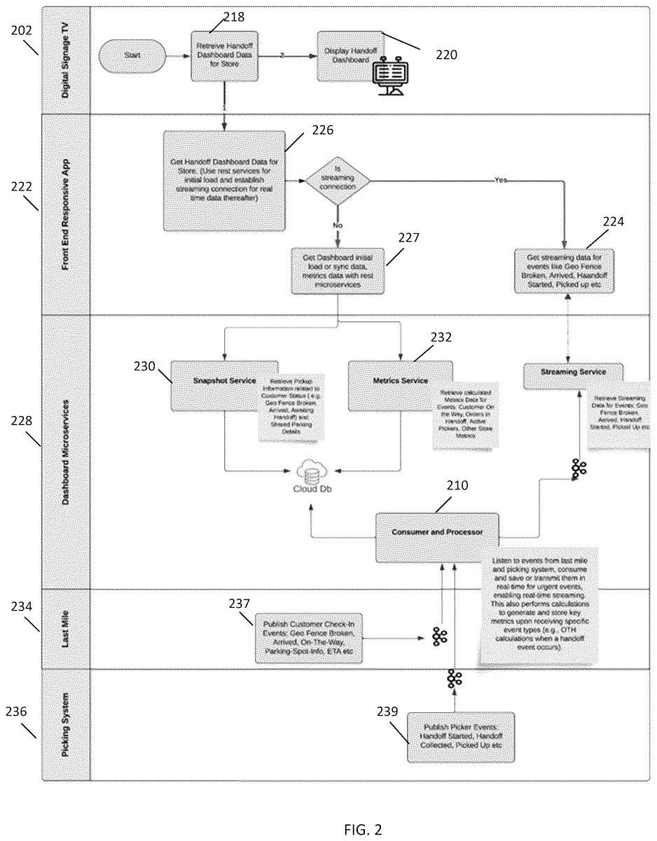

FIG. 2 illustrates a flowchart of coordination of the various systems, data, and service elements of the platform. By way of example, a process for coordinating prioritizing and alerting users for drive-up-and-go orders can start at the digital signage display 202 by retrieving the data regarding predetermined events related to DUG orders for a particular store the user is located in 218 and displaying it in a dashboard format 220. The retrieval may be via a front-end responsive application 222, such as a web-based application that allows both live streaming of real-time updates DUG-relevant events 224, and retrieval of existing data for DUG-relevant events via REST (representational state transfer) microservices 226, 227. Dashboard microservices 228 provide both the real-time streaming service and REST services. In the real-time update process, the streaming data for predefined events from both the picking system and the last mile system are provided. In the REST process, a snapshot service 230 stores and holds predefined events from the last mile system and picking up system for retrieval by the front-end responsive application 222. Similarly, a metrics service 232 stores metrics data relevant to predefined events. For example, the central processor 210 can listen to predefined events from the last mile and picking system, consume and save them for the REST service, or transmit them in real-time. In some embodiments, the system may switch between REST services and real-time transmitting via a streaming service 233 when the processor identifies that an urgent event has occurred in the picking system or last mile system. Central processor 210 is also configured to perform calculations to generate and store key metrics upon receiving specific predefined event types. Examples of key metrics include on-time hand-off calculations, elapsed time from various events, active and available pickers, numbers of orders in each status category (e.g. customer on the way, geo-fence broken, handoff started, picking started). The last mile system 234 may include an application that communicates with the central processor 210 to communicate a number of predefined events to the display or the audio server related to the customer, specifically customer check-in events, such as a geo-fence being broken, customer en route, customer estimated time of arrival, customer arrival, customer parking spot location on arrival 237. These customer events may be provided via geolocation services in the application as well as by the customer inputting updates in the application. The picking system 236 may include an application that communicates with the central processor 210 to communicate a number of predefined events related to the picker who packages the customer order, such as order picked up or packaged, handoff order started, and handoff collected 239.

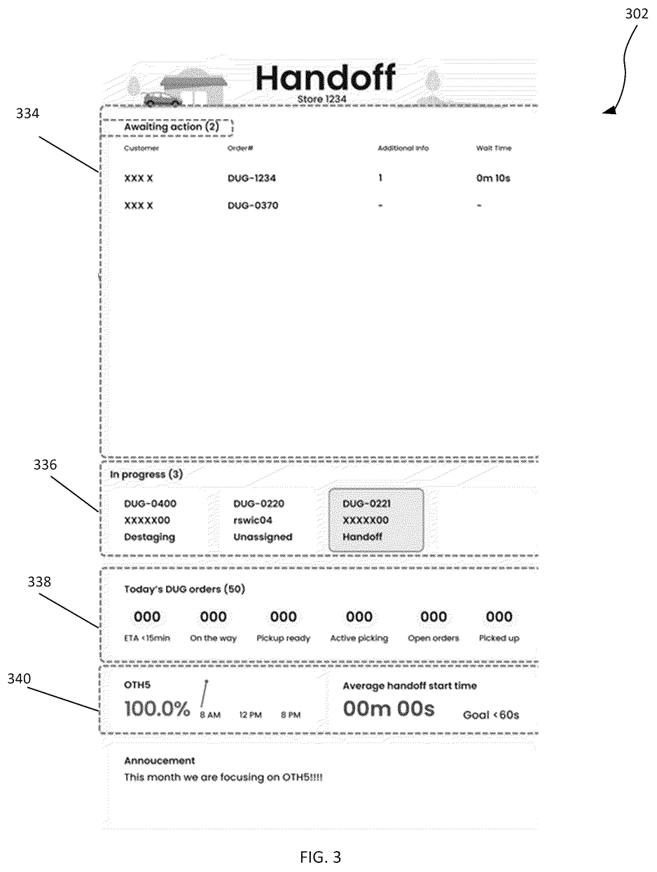

FIG. 3 is an exemplary visual signage display 302 showing an exemplary prioritization of the dashboard layout order, space and size, to direct a user, such as a picker's attention to the orders awaiting action and their elapsed time since the customer has arrived or since a geo-fence has been broken. For example, the top of the display may prioritize showing a list of the orders awaiting action 334 for customers who have satisfied a predefined check-in event in the last mile system such as customers who are en route based on estimated time of arrival, have arrived, have parked, or customers who have otherwise broken a pre-defined geo-fence. An order leaves the awaiting action section and moves to the in progress section 336 once an associate or picker performs a predefined action. Action may be any task required by operations to create progress on an e-commerce order, for example, gathering an order from the staging area or handing it off to a customer. In the system architecture, an action may be communicated via multiple channels, such as call-to-action messages over the PA system, SMS, and/or push notifications to and from the picking system and corresponding handheld devices. The below definitions of various terms describing actions performed by store associates throughout the disclosure include:
Picking
   The task in which a shopper selects items for an order and assembles them in a cart.
Staging
   The task in which an associate packs the picked items into bags, labels them, and stores them in a dedicated area, rack, or other location for later handoff to a customer or delivery driver.
Destaging
   The task in which an associate removes packed bags from racks or designated areas and places them into a cart for handoff to customers in the parking lot or to a delivery driver.
Handoff
   The task in which an associate hands off the bags and/or items from an order to a customer or delivery driver.

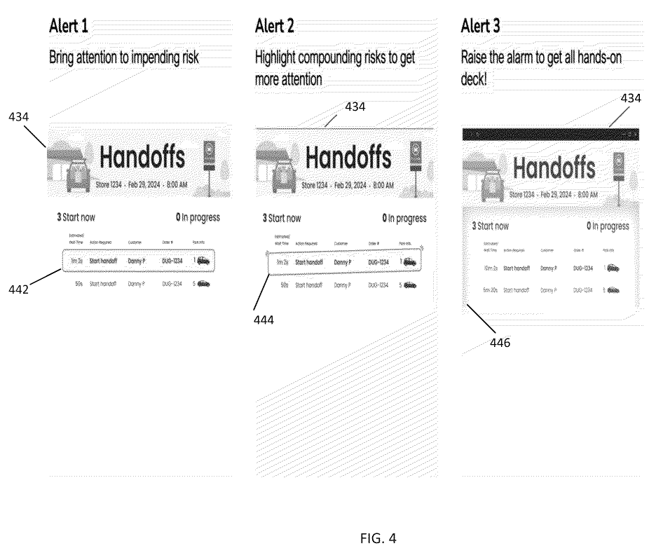

The predefined action may be an associate selecting a handheld device to start the task. The in-progress section of the display indicates the current handoffs that are being worked on by pickers and their status. In the in-progress status section there may be additional and less urgent alerts. For example, handoff being highlighted indicates that the customer has already been waiting for another predefined time period without further updates from the associate. It signifies that the handoff is delayed and at risk of missing operational goals. The in-progress section is relatively smaller and lower in the display as action is already being taken on the order so it no longer requires prioritized attention. By maintaining this delineation of awaiting action and in progress in the display as well as the relative size and location of the awaiting action within the display, this allows the “start now” escalation described in FIG. 4 to most readily command a user's attention. Orders summary 338 provide the state of all the DUG orders for the day in the store location. The display can also show other actionable KPIs for the store 340 at the bottom such as on-time hand-off (OTH) average and trend against a target goal or how much time has elapsed between the awaiting action and the handoff in progress.

FIG. 4 illustrates an exemplary gradation of escalating visual notification via a progression of three alerts in response to predefined thresholds in the orders awaiting action 434 section of the display in FIG. 3. Alert 1 442 highlights a vehicle from a list of vehicles awaiting action that has been waiting for a handoff that has exceeded a certain threshold, in this example a time threshold. The second vehicle in the list is still below the threshold so the first alert color codes the customer in need of more immediate attention, by highlighting the user in a highlighted bar, to direct the user's attention to that order. Alert 2 444 shows when a second threshold has been exceeded an additional visual alert such as a shaking motion of the highlight bar to further get the user's attention. Alert 3 446 shows that a third threshold has been exceeded, and that another customer has also exceeded the threshold, so highlight bar has been enlarged and may flash. In scenarios where additional customers do not exceed thresholds, the original highlight bar may maintain its size and flash. Thresholds may include one or more of time and/or number of vehicles waiting. Although there are three alerts illustrated, more or fewer alerts may be deployed. Visual alerts 1-3 are configured to progressively communicate greater urgency. In this manner, the user can easily and quickly ascertain which orders need action and how urgently they need action.

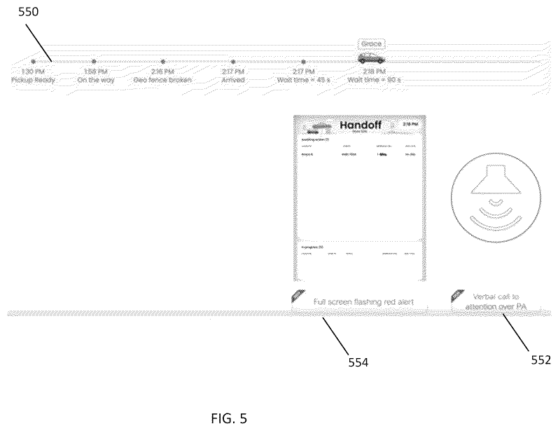

FIG. 5 shows a vehicle waiting timeline 550 with various timing thresholds that may control the one or more alerts in FIGS. 1-4. As illustrated in FIG. 5, any of one or more of the disclosed visual dashboard alerts 554 may also include a corresponding audio alert 552, for example over a store PA system. In some embodiments, the audio alerts are a specific chime notification that occurs when the customer arrives, e.g. the geo-fence is broken, and when 90 seconds from arrival, the order has not been acted upon and is awaiting action. The second audible alert is cancelled in response to an order moving from awaiting action to in progress. An exemplary action of an order moving to in-progress is an associate selecting a handheld device to start the picking task. In some embodiments the audible alerts follow the same timing and progression as the visual alerts in FIG. 4. In some embodiments, the processor bundles multiple visual and audio alerts corresponding to multiple orders as a single alert visual and/or audible alert if a plurality of order vehicle customer check-in events occur within a certain time period (e.g. within a 30 or 20 or 10 second window). For example, if three vehicles are break the geo-fence within thirty seconds of each other, then by the time a first, second or third alert threshold is met for any of the three vehicles, then the first visual indicator may highlight all three orders and the a single audible alert may be provided over the store intercom representing all three orders. In some embodiments, the audible alert representing multiple orders is distinguishable from the audible alert representing a single order (e.g. the duration of the specific chime notification may be longer).

Disclosed embodiments further encompass extended accessibility of the visual dashboard across multiple computing devices. In some embodiments, the real-time dashboard is configured to be accessible on in store-monitors as well as via one or more additional user devices, including but not limited to laptop computers, tablet devices, and mobile phones. This extended accessibility enables store directors and authorized personnel to monitor operational status and alerts remotely or while in transit within or outside the store premises.

When the platform is accessed on such additional user devices, the alerting mechanism includes both the visual and audio components. Upon the occurrence of a triggering or alerting event, a visual alert is presented on the user interface of the device in conjunction with an accompanying audio alert.

The audio alert may generated locally on the accessing user device through a browser-based application programming interface (API) or equivalent system-level interface. The browser API interacts with the underlying operating system of the device to output sound through one or more available audio output components, such as built-in speakers or connected audio peripherals. The audio alert is played automatically provided that the device audio is not muted or otherwise disabled by the user or system settings.

This multi-device alerting capability ensures timely and consistent notification delivery across distributed personnel, thereby improving responsiveness and operational efficiency beyond fixed-location display systems.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A system for prioritizing and alerting users for drive-up-and-go (DUG) orders comprising:
a visual display configured to display and prioritize DUG orders based on a vehicle check-in event and other real-time information,
a processor configured to push updates to the visual display based on time lapsed since vehicle check-in event including an alert that changes in how a vehicle priority is displayed and configured to push updates to an audible alert system to provide an audible alert based on elapsed time from the vehicle check-in event.

2. The system of claim 1, further comprising a last mile event system, which detects and communicates the vehicle check-in event to the processor.

3. The system of claim 2, wherein a last mile event system detects the vehicle check-in event via geolocation services in the application or by a customer inputting updates in a user interface.

4. The system of claim 2, further comprising a picking event system, wherein the picking events system includes a handheld device in communication with the processor.

5. The system of claim 4, wherein the picking event system provides updates to the status of the drive-up-and-go orders in the visual display.

6. The system of claim 5, wherein the picking event system provides updates that the order is in progress when a handheld tablet is activated for the DUG order.

7. The system of claim 1, wherein the processor is configured to coordinate the visual alert and the audible alert based on the time lapsed.

8. The system of claim 7, wherein the processor is configured to coordinate escalating visual and audible alerts based on predefined and longer time lapses.

9. The system of claim 8 wherein the processor is configured to cancel the audio alert and the escalating audio alerts, and to update the visual display in response to detection that the DUG order is in progress.

10. The system of claim 1, wherein the processor is further configured to identify that the vehicle check-in event has occurred for multiple DUG orders within a predefined period of time, and in response, to coordinate a single visual alert and a single audible alert corresponding to the time lapse for the multiple DUG orders.

11. The system of claim 9, wherein the processor is configured to coordinate an escalating visual alert and an escalating audible alert for the multiple DUG orders based on predefined and longer time lapses.

12. The system of claim 10, wherein the processor is configured to cancel the audio alert and updating the visual and audio alerts including canceling the audio alerts.

13. The system of claim 1, wherein the processor is further configured to identify that the vehicle check-in event has occurred for multiple DUG orders, and in response, to coordinate visual alerts to prioritize and signal which order should be handled first based the time lapse for the multiple DUG orders.

14. The system of claim 13, wherein, in response to the time lapse for the multiple DUG orders exceeding a threshold, the processor coordinates a single alert for all of the multiple DUG orders, wherein the single alert communicates the urgency is greater than that of any previous alerts.

15. The system of claim 13, wherein, in response to a total number of DUG order vehicle check-in events exceeding a threshold, the processor the processor coordinates a single visual alert for all of the DUG orders, wherein the single visual alert communicates the urgency is greater than that of any previous alerts.

16. The system of claim 1, wherein the audible alert system is an store public announcement system.

17. The system of claim 1, wherein the visual display comprises a plurality of in-store digital displays.
